(19) United States
(12) Patent Application Publication
(10) Pub. No.: US 2024/0313495 A1
(43) Pub. Date: Sep. 19, 2024

(54) CRIMPING UNIT FOR A CRIMPING TOOL

(71) Applicant: MD Elektronik GmbH, Waldkraiburg (DE)

(72) Inventors: Lukas STEINMAIER, Muehldorf am Inn (DE); Walter LANG, Waldkraiburg (DE); Jens HERMES, Sankt Wolfgang (DE)

(21) Appl. No.: 18/599,243

(22) Filed: Mar. 8, 2024

(30) Foreign Application Priority Data
Mar. 15, 2023 (DE) 10 2023 106 464.9

(51) Int. Cl. H01R 43/058

(52) U.S. Cl. CPC H01R 43/0585

(57) ABSTRACT

A crimping unit for radially crimping a crimp barrel along a circumference of the crimp barrel onto a cable includes a plurality of radially displaceable crimping jaws arranged in a circumferential direction, which press the crimp barrel onto the cable in a crimping position. The crimping unit further includes a retaining ring, in which the crimping jaws are accommodated in a radially displaceable manner, and an actuating ring axially displaceable relative to the retaining ring. An axial displacement of the actuating ring in a first direction enables radial displacement of the crimping jaws in the retaining ring into the crimping position. An axial displacement of the actuating ring in a second direction enables an active section of the actuating ring to interact with an active surface of a crimping jaw such that it is movable from the crimping position into a radially spaced position.

### CROSS REFERENCE TO RELATED APPLICATIONS

This application claims benefit to German Patent Application No. DE 10 2023 106 464.9, filed on Mar. 15, 2023, which is hereby incorporated by reference herein.

### FIELD

The invention relates to a crimping unit for a crimping tool configured in particular as a hand tool and to a crimping tool with a crimping unit.

### BACKGROUND

From the cable processing practice, in particular from cable assembly, it is generally known to attach an essentially hollow-cylindrical crimp barrel to a conductor of a cable, in particular to the electrical conductor at a stripped cable end, by means of crimping. During crimping, the hollow-cylindrical crimp barrel is plastically deformed by a so-called cold extrusion under the effect of a defined external force in such a way that the crimped sleeve is permanently attached to the stripped cable end.

To perform the crimping, it is known that the cable end provided with the crimp barrel is inserted into a crimping unit, the crimp barrel being initially loosely arranged on the cable end. Thereby the crimping unit comprises a plurality of crimping jaws surrounding the crimp barrel in the circumferential direction, the respective crimping jaw having a crimping surface, which under certain circumstances may be contoured, on an end face pointing towards the crimp barrel. When the crimping jaws are simultaneously displaced towards the crimp barrel, the crimping jaws reach a crimping position, in which the respective crimping jaw rests with the respective crimping surface against a circumferential section of the crimp barrel and exerts a force on the crimp barrel, so that the respective crimping jaw plastically deforms the crimp barrel in the respective circumferential section. When actuated simultaneously, all crimping jaws deform the crimp barrel thereby essentially uniformly and approximately annularly in the circumferential direction of the crimp barrel, whereby a radially protruding section may remain on the crimp barrel between adjacent crimping jaws in the circumferential direction.

It is known to provide a retaining ring for the plurality of crimping jaws arranged in the circumferential direction, which press the crimp barrel onto the conductor in the crimping position, in which the respective crimping jaw is accommodated so that it can be displaced radially in the direction of the crimp barrel to be crimped. Thereby the retaining ring defines an axis, with respect to which the conductor with the loosely attached crimp barrel is inserted into the crimping position, whereby a radial direction can be defined with respect to this axis.

An actuating device is provided for the simultaneous, synchronized actuation of the crimping jaws, which are accommodated in the retaining ring in a radially displaceable manner, the actuation of which simultaneously displaces all the crimping jaws accommodated in the retaining ring in a displaceable manner radially towards the crimp barrel into the crimping position and/or displaces the crimping jaws radially away from the crimp barrel from the crimping position into a radially spaced position.

It is known from the prior art, for example, to provide a cam plate as an actuating device, which is rotatably mounted and whose rotation displaces the radially displaceable crimping jaws into the crimping position and/or moves them from the crimping position into a radially spaced position (EP 3 012 923 B1).

U.S. Pat. No. 8,024,855 B2 describes a crimping unit for crimping a first section of a crimp barrel onto the stripped section of a cable and the second section of the crimp barrel onto the adjacent cable sheath. In order to crimp the first section of the crimp barrel, the crimping unit has four crimping jaws, which are arranged at 90° intervals around the first section of the crimp barrel and which are guided radially displaceable in relation to the crimp barrel. In order to move the four crimping jaws into the crimping position, a ring is provided as the first actuating device, which interacts with a sloped inner side with a radially exterior, also sloped, outer side of the respective crimping jaw in such a way that the respective crimping jaw is displaced radially into the crimping position when the ring is axially displaced. Thereby the radial displacement of the respective crimping jaw into the crimping position takes place against the restoring force of a spring, so that a separate return spring is provided for each crimping jaw. If the ring is axially displaced in the opposite direction, the return springs cause the respective crimping jaw to be displaced into the initial position, which is at a distance from the crimping position. In order to press the second section of the crimp barrel onto the cable sheath adjacent to the stripped section, eight further crimping jaws are provided, which surround the second section of the crimp barrel offset by 45°, whereby each one of the eight further crimping jaws are movable by a rotatably mounted cam plate as a second actuating device towards the crimping position and from the crimping position into a spaced-apart position. In order to crimp a single crimp barrel, in particular two different actuating devices are provided, which are to be actuated one after the other with each actuating device being assigned its own set of crimping jaws.

### SUMMARY

In an embodiment, the present disclosure provides a crimping unit for radially crimping a crimp barrel along a circumference of the crimp barrel onto a cable. The crimping unit includes a plurality of radially displaceable crimping jaws arranged in a circumferential direction, which press the crimp barrel onto the cable in a crimping position. The crimping unit further includes a retaining ring, in which the crimping jaws are accommodated in a radially displaceable manner, and an actuating ring, which is axially displaceable in relation to the retaining ring. Upon an axial displacement of the actuating ring in a first direction, the crimping jaws in the retaining ring are radially displaceable into the crimping position. The actuating ring is configured such that, in case of an axial displacement of the actuating ring in a second direction opposite to the first direction, an active section of the actuating ring interacts with an active surface of a respective one of the crimping jaws such that the respective crimping jaw is movable from the crimping position into a radially spaced position . . .

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective top view of an embodiment of a crimping unit according to the invention;

FIG. 2 shows a partially sectioned perspective view of the crimping unit from FIG. 1, along the cutting plane line A-A;

FIG. 3 shows the detail ‘Z’ from FIG. 2 in an enlarged view;

FIG. 4 shows a perspective top view of the crimping unit from FIGS. 1 to 3;

FIG. 5 shows a partially sectioned perspective view of the crimping unit from FIG. 4, along the cutting plane line B-B;

FIG. 6 shows the detail ‘Y’ from FIG. 5 in an enlarged view;

FIG. 7 shows a perspective view of the retaining ring and the crimping jaws of the crimping unit from FIGS. 1 to 6;

FIG. 8 shows a perspective view of a crimping jaw of the crimping unit from FIGS. 1 to 7;

FIG. 9 shows a perspective view of a section of the crimping jaw from FIG. 8; and

FIG. 10 shows a partially sectioned perspective view of the actuating ring of the crimping unit from FIGS. 1 to 9.

### DETAILED DESCRIPTION

In an embodiment, the present invention provides a crimping unit that has a simple configuration and is particularly suitable for a crimping tool configured as a hand tool.

A crimping unit that has a simple configuration and is particularly suitable for a crimping tool configured as a hand tool is provided, according to an embodiment of the present invention, by a crimping unit, in particular for a crimping tool, for radially crimping a crimp barrel along the circumference of the crimp barrel onto a cable, the crimping unit comprising:
a plurality of radially displaceable crimping jaws arranged in the circumferential direction, which press the crimp barrel onto the cable in a crimping position,
a retaining ring, in which the crimping jaws are radially displaceably accommodated, and
an actuating ring, which is axially displaceable relative to the retaining ring,
wherein in the case of axial displacement of the actuating ring in a first direction, the crimping jaws in the retaining ring are radially displaceable into the crimping position, and
wherein the actuating ring is configured such that when the actuating ring is axially displaced in a second direction opposite to the first direction, an active section of the actuating ring interacts with an active surface of the respective crimping jaw in such a way that the respective crimping jaw is displaceable from the crimping position into a radially spaced position.

Another embodiment of the present invention provides a crimping tool comprising a housing and the above-mentioned crimping unit according to an embodiment of the present invention, wherein the retaining ring of the above-mentioned crimping unit is fixedly arranged on the housing.

It has proved advantageous that the axial displacement of the actuating ring in one of two opposing directions allows either the crimping jaws to be moved into the crimping position or moved from the crimping position into a radially spaced position, so that additional parts, such as return springs or preload springs, can be dispensed with. In particular, it is no longer necessary to move the crimping jaws against the pre-load of springs, so that less force is required. The crimping unit has a particularly simple and small configuration and is especially suitable if the crimping tool is configured as a hand tool, i.e. can be operated manually by an operator, possibly only by a movement of the hand.

Preferably, it is provided that the active surface on the respective crimping jaw has a first surface section and a second surface section, and whereby the two surface sections lie opposite each other in the region of a shank of the crimping jaw. The respective crimping jaw can have a simple configuration and is actuated essentially symmetrically relative to a longitudinal axis, so that a tilting of the respective crimping jaw can be avoided when it is actuated.

Preferably, it is provided that the active section of the actuating ring has a first surface section and a second surface section, and the two surface sections are arranged in a spaced apart manner by the crimping jaw. The respective crimping jaw is guided laterally between the two surface sections of the active section of the actuating ring.

During the axial displacement of the actuating ring relative to the retaining ring, the active section of the actuating ring can interact with the respective active surface of the crimping jaw as a pair of surfaces interacting with each other, in particular as wedge surfaces of a pair of surfaces that slide back and forth relative to each other. The equivalent applies if one of the two surface sections of the active section of the actuating ring interacts with the surface section of the active surface of the crimping jaw assigned to it.

Preferably, it is provided that the respective crimping jaw has a step on one crimping surface in the direction of the axial extent. Thereby the crimping surface has two crimping surface sections with a different radius that are spaced apart in the axial direction by the step. Due to the radial displacement of the crimping jaw, a single movement of the crimping jaw into the crimping position allows both a first section of the crimp barrel to be attached to the stripped section of the cable as well as a second section of the crimp barrel to be attached to the cable sheath of the cable.

Preferably, it is provided that the retaining ring has an annular body with receiving grooves for the respective crimping jaws and a cover plate axially covering the retaining ring. The cover plate can be removed in order to replace individual or all crimping jaws, for example.

Furthermore, it may be provided that a pressure surface is formed on the respective crimping jaw, and wherein a counter-pressure surface for the pressure surface of the respective crimping jaw is formed on the actuating ring, and wherein the actuating ring is configured such that, during the axial displacement of the actuating ring in the first direction, the counter-pressure surface of the actuating ring interacts with the pressure surface of the respective crimping jaw such that the respective crimping jaw is radially displaceable into the crimping position.

In particular, it is preferably provided that the pressure surface of the respective crimping jaw is formed parallel to the active surface of the same crimping jaw, and that the counter-pressure surface of the actuating ring of the respective crimping jaw is formed parallel to the active section of the actuating ring interacting with this crimping jaw.

A special embodiment of this provides for the respective crimping jaw that the crimping jaw has an essentially T-shaped end section, with the pressure surface being formed on the radially outer side of the T and the active surface on the radially inwardly pointing side of the T. With regard to the actuating ring, it is provided that the T-shaped end section of the crimping jaw is guided in a guide groove in the actuating ring, with the counter-pressure surface being formed on a radially inwardly pointing groove base and the active section being formed on a radially outwardly pointing surface of a protrusion protruding into the guide groove.

With regard to the T-shaped end section of the crimping jaw, it is provided in particular that the T-shaped end section of the crimping jaw is arranged in the guide groove with a radial clearance.

Further it is provided that in the crimping position the actuating ring is arranged such that it is completely pushed onto the outer circumference of the retaining ring. The crimping position of the crimping jaws corresponds to the maximum displacement path of the actuating ring.

A further embodiment of the present invention comprises a crimping tool configured in particular as a hand tool, comprising a housing and a crimping unit according to an embodiment of the present invention arranged in the housing, wherein the retaining ring of the crimping unit is fixedly arranged on the housing. The crimping tool further comprises a drive, which is arranged in the housing or at one end of the housing, wherein the drive is configured as a linear drive with a linearly driven shaft or a hydraulically and/or pneumatically driven piston and wherein the shaft or the piston acts on the actuating ring of the crimping unit. In particular, it is provided that a rigid coupling element is provided between the shaft or the piston and the actuating ring, wherein the shaft or the piston is articulated to the coupling element on the drive side and wherein the coupling element is fastened to the actuating ring at several points in the circumferential direction of the actuating ring. The crimping unit is configured in particular as an interchangeable head relative to the drive, in the sense that the shaft or the piston of the drive can be coupled to the interchangeable head and/or released from the interchangeable head, as required. The drive is configured in particular as a battery-operated hydraulic drive.

In a further embodiment of the present invention, it is provided that the rigid coupling element is attached to the actuating ring, with the drive acting on the coupling element, and furthermore that an extension extending axially in the direction of the drive, in particular an additional part attached to the retaining ring as an adapter, is provided on the retaining ring, with the extension and/or the adapter forming a stop during the linear movement of the coupling element. If the coupling element is moved against the stop, the crimping jaws reach the radially most lowered position, i.e. the crimping position. The radially most lowered position of the crimping jaws can then be set and/or determined by the relative position, in which the extension and/or the adapter forms a stop with the coupling element, in particular, the crimp height and/or the degree of crimping of the crimp barrel can be set. Even in this maximum radially lowest position of the crimping jaws, a gap can remain between adjacent crimping jaws. The stop, in particular thus also the relative position of the extension and/or the adapter on the retaining ring relative to the axially displaceable actuating ring, determines in particular the degree, to which the actuating ring can be displaced on the retaining ring, in particular a reversal point of the actuating ring on the retaining ring, at which the crimping jaws are in the crimping position.

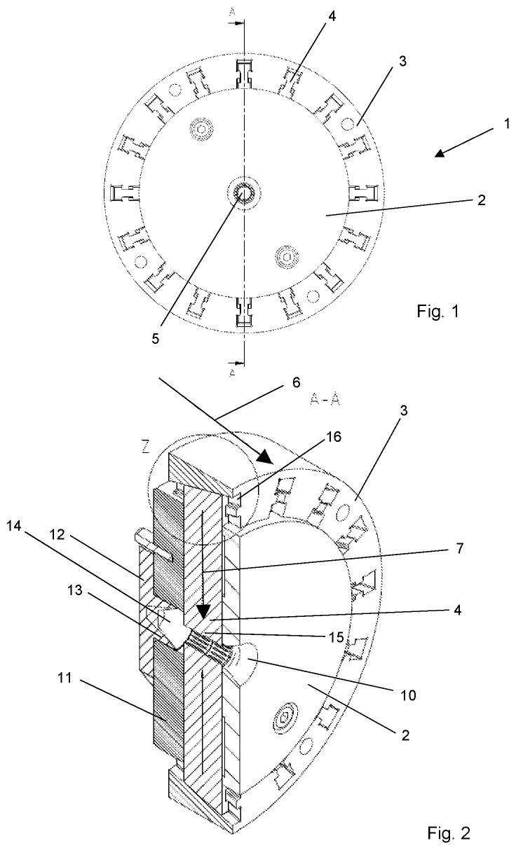

FIG. 1 shows a view of a crimping unit 1. The crimping unit 1 is configured to attach a crimp barrel to an optical or electrical conductor of a cable. The main components of the crimping unit 1 are a retaining ring 2 and an actuating device configured as an actuating ring 3. The retaining ring 2 is essentially configured as a plate-shaped annular body with a central through-hole, in which a plurality of at least three, in the illustrated exemplary embodiment sixteen, similarly configured crimping jaws, which are described in more detail below, are arranged to be radially displaceable in relation to the central through-hole of the plate-shaped annular body.

Of the total of sixteen crimping jaws, one is marked with the reference number ‘4’ in the illustration in FIG. 1. The actuating device, configured as an actuating ring 3, accommodates an end section of each crimping jaw 4, whereby the respective crimping jaw 4 is also guided in a slidable manner in the retaining ring 2.

The actuating ring 3 is configured as an essentially hollow-cylindrical ring part, the cylindrical inner side 33 (FIG. 10) of which is guided on the outer side 25 of the retaining ring 2. A ring axis of the actuating ring 3 and the central axis of the plate-shaped annular body of the retaining ring 2 coincide and form a common axis, in relation to which a radial direction and an axial direction (perpendicular to the paper plane of the illustration of FIG. 1) are defined. Along this axis, an end of a cable provided with the crimp barrel, in particular stripped at the end, can be inserted in such a way that a simultaneous actuation of all crimping jaws 4 presses the crimp barrel on the end of the cable and thus crimps it. The radially inner end sections of all crimping jaws 4 thereby delimit a near-axis region 5, which can be used to crimp the crimp barrel onto the cable in the shown crimping position of the respective crimping jaw 4.

FIG. 1 thus represents a crimping unit 1 that is configured to fasten a crimping barrel arranged in the near-axis region 5, to a cable by a radial crimping of the crimping barrel along the circumference of the crimping barrel, the crimping unit comprising a plurality of crimping jaws 4 arranged in the circumferential direction and radially displaceable and which, when brought into the crimping position, crimp the crimping barrel onto the cable, the crimping unit comprising a plurality of radially displaceable crimping jaws 4 which, when brought into the crimping position, crimp the crimp barrel onto the cable, wherein the crimping unit further comprises the retaining ring 2, in which all the crimping jaws 4 are each individually accommodated in a radially displaceable manner. Furthermore, the crimping unit 1 has the actuating ring 3 as a further component, wherein the actuating ring 3 is arranged axially relative to the retaining ring 2, in the illustration of FIG. 1 perpendicular to the paper plane, displaceably on the outer side of the retaining ring 2, in particular slidingly guided.

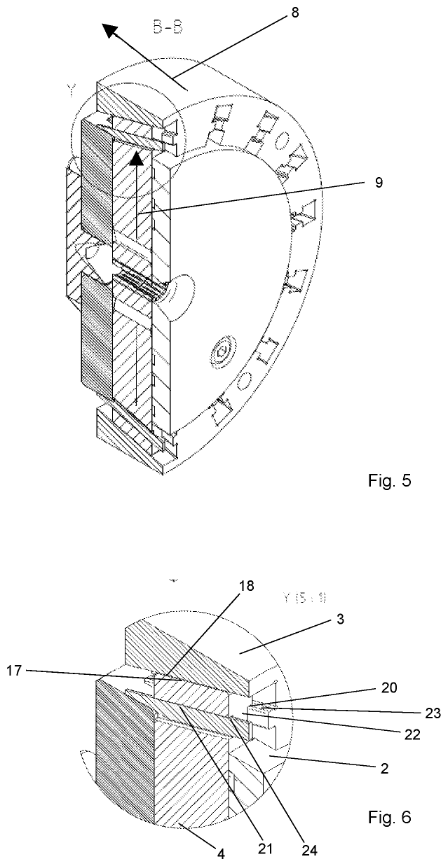

The crimping unit 1 and/or, in particular, the actuating ring 3 of the crimping unit 1 is configured such that, when the actuating ring 3 is displaced axially in a first direction (arrow 6 in FIG. 2), the crimping jaws 4 in the retaining ring 2 can be displaced radially into the crimping position, i.e. towards the axis (arrow 7 in FIG. 2). Furthermore, the crimping unit 1 and/or the actuating ring 3 of the crimping unit 1 is configured such that when the actuating ring 3 is axially displaceable in a second direction opposite to the first direction 6 (arrow 8 in FIG. 5), the crimping jaws 4 can be displaced in the opposite radial direction (arrow 9 in FIG. 5), i.e. out of the crimping position into a radially spaced position. In the exemplary embodiment shown, it is therefore provided that, when the actuating ring 3 is displaced towards the retaining ring 2, the crimping jaws 4 are displaced radially towards the axis, and that, when the actuating ring 3 is displaced away from the retaining ring 2, the crimping jaws 4 are displaced radially away from the axis. For the displacement of the crimping jaw 4 from the crimping position into the radially spaced position, it is provided in particular that an active section of the actuating ring interacts with an active surface of the respective crimping jaw in such a way that the respective crimping jaw can be displaced from the crimping position into a radially spaced position, as will be explained in more detail below, in particular with reference to FIGS. 5 and 6.

FIG. 2 shows the crimping unit 1 from FIG. 1 in a partially perspective view cut along the axis A-A. It can be seen that the retaining ring 2 has a conically tapering insertion opening 10 concentric to the axis, into which the stripped cable end provided with the crimp barrel can be inserted. Essentially axially opposite the insertion opening 10, the retaining ring 2 has a cover plate 11 axially covering the retaining ring 2. The cover plate 11 is detachably attached to the plate-shaped annular body of the retaining ring 2 and can be removed, for example to replace an individual, for example, damaged crimping jaw 4 or all crimping jaws 4, the latter in particular in the event that a different crimp barrel is to be crimped, for which differently dimensioned crimping parameters are required.

FIG. 2 further shows that an end part 12 is arranged on the cover plate 11, which engages with a cone-like protrusion 13 in a recess 14 of the cover plate 11, whereby the protrusion 13, about which the retaining ring 2 and the actuating ring 3 are jointly centered, is also arranged centrally on the axis. The cone-like protrusion 13 forms an axial stop for the cable end provided with the crimp barrel to be crimped, so that the cable end provided with the crimp barrel can be inserted aligned and centered between the crimping jaws 4 arranged circumferentially around the axis, with the crimp barrel to be crimped being accommodated between the crimping jaws 4.

In the exemplary embodiment shown, the sixteen crimping jaws 4 are of similar configuration, so that only the crimping jaw marked with the reference number ‘4’ is described in more detail below.

FIG. 2 shows that the crimping jaw 4 with a first end section has a crimping surface 15, which can have a convex contour, for example, so that in the crimping position the crimping surface 15 of the respective crimping jaw 4 deforms the crimp barrel in a convex manner. All crimping jaws then deform the crimp barrel with an overall essentially circular cross-sectional profile with a reduced diameter compared to the non-crimped crimp barrel.

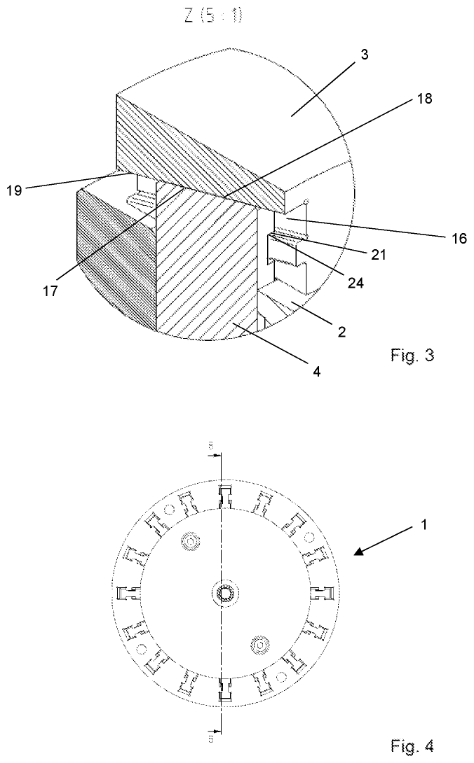

At a second end section radially opposite the first end section, the crimping jaw 4 has a sloped surface which, in the illustration in FIG. 2, rests against a similarly sloped surface of a groove of the actuating ring 2. The two sloped surfaces act together as a pair of wedge surfaces, as explained in more detail below with reference to FIG. 3.

FIG. 2 further shows that the retaining ring 2 is configured as a plate-shaped annular body with receiving grooves, whereby a radially extending receiving groove is configured for each of the crimping jaws 4 and whereby the retaining ring 2 has the cover plate 11 covering it axially. The respective crimping jaw 4 is accommodated axially between a base of the receiving groove and the cover plate 11 and is radially displaceable in the circumferential direction of the retaining ring by two lateral flanks of the receiving groove. As can also be seen from FIG. 2, the second end section of the crimping jaw 4 is guided in a guide groove 16 in the actuating ring 3; in particular, the respective second end section of the respective crimping jaw 4 is guided in its own guide groove 16 in the actuating ring 3.

FIG. 3 shows the detail ‘Z’ from FIG. 2, in particular the second end section of the crimping jaw 4 guided in the guide groove 16 in the actuating ring 3 in an enlarged view. It can be seen that a pressure surface 17 is formed on the crimping jaw 4, this pressure surface 17 is configured as a sloped surface on an end of the crimping jaw 4 pointing radially away from the near-axis crimping region 5. FIG. 3 also shows that a counter-pressure surface 18 is formed on the actuating ring 3 for the respective pressure surface 17 of the crimping jaw 4. The counter-pressure surface 18 of the actuating ring 3 is also configured as a sloped surface and is arranged on a radially inwardly pointing groove base 19. The pressure surface 17 on the crimping jaw 4 and the counter-pressure surface 18 corresponding to the pressure surface 17 on the groove base 19 of the actuating ring 3 are formed as surfaces complementary to each other, in particular as wedge surfaces of a pair of wedge surfaces.

If the actuating ring 3 is displaced axially in the first direction 6 (FIG. 2) relative to the crimping jaw 4, which is accommodated in the retaining ring 2 so as to be displaceable exclusively in the radial direction, the pressure surface 17 and the counter-pressure surface 18 slide flatly against each other. Due to the one-piece configuration of the actuating ring 3 and the exclusively radial displaceability of the crimping jaw 4, the crimping jaw 4 is thereby displaced in the radial direction in the direction of the axis into the crimping position; the forces required for the plastic deformation of the crimping barrel are applied by the actuating ring 3 and the respective crimping jaws 4.

FIG. 4 and FIG. 5 show the crimping unit 1 with an axial displacement of the actuating ring 3 in a second direction (arrow 8), which is opposite to the first direction (arrow 6 in FIG. 2). It should be noted that the cutting plane line B-B in FIG. 4 is slightly offset in relation to the cutting plane line A-A in FIG. 1.

FIG. 6 shows the detail ‘Y’ from FIG. 5 in an enlarged view. It can be seen that an active section is provided on the actuating ring 3, which interacts with an active surface of the crimping jaw 4 in such a way that the crimping jaw 4 is displaced from the crimping position into a radially spaced position (arrow 9 in FIG. 5) when the actuating ring 3 is displaced axially in the second direction (arrow 8 in FIG. 5).

Thereby it is provided that the active surface on the respective crimping jaw 4 has a first surface section 20 and a second surface section 21, with the two surface sections 20, 21 lying opposite each other in the region of a shank 22 of the crimping jaw 4. The active surface of the respective crimping jaw 4, in particular the two surface sections 20, 21, thereby interact with an active section of the actuating ring 3. The active section of the actuating ring 3 has a first surface section 23 and a second surface section 24, with the two surface sections 23, 24 being spaced apart by the crimping jaw 4.

The active surface of the respective crimping jaw 4 interacts with the active section of the actuating ring 3, in particular the first surface section 20 of the crimping jaw 4 interacts with the first surface section 23 of the actuating ring 3 and the second surface section 21 interacts with the second surface section 24 of the actuating ring 3, wherein the first surface sections 20, 23 and the second surface sections 21, 24 are each formed as mutually complementary wedge surfaces of a pair of interacting wedge surfaces, wherein the wedge surfaces of the respective pair of wedge surfaces slide on each other in a planar manner when the actuating ring 3 is axially displaced in the direction of the arrow 8 (FIG. 5).

Thereby a gap is formed between the pressure surface 17 of the crimping jaw 4 and the counter-pressure surface 18 of the actuating ring, so that no force is transmitted from the counter-pressure surface 18 to the pressure surface 17. Accordingly, in the illustration in FIG. 3, a gap is formed between the active surface (surface section 21) and the active section (surface section 24), while the counter-pressure surface 18 presses the pressure surface 17 radially in the direction of the crimping position.

It should be noted that the displacement of crimping jaw 4 from the crimping position into a radially spaced position is carried out by providing the active surface 20, 21 on the respective crimping jaw 4 and the active section 23, 24 of the actuating ring 3 interacting with the active surfaces 20, 21, i.e. by a defined shaping of the crimping jaw 4 and the actuating ring 3; in particular, no additional parts such as return springs are required, so that the installation space can be reduced and the contact pressure, with which the respective crimping jaw 4 deforms the crimp barrel does not have to be applied against possible restoring forces.

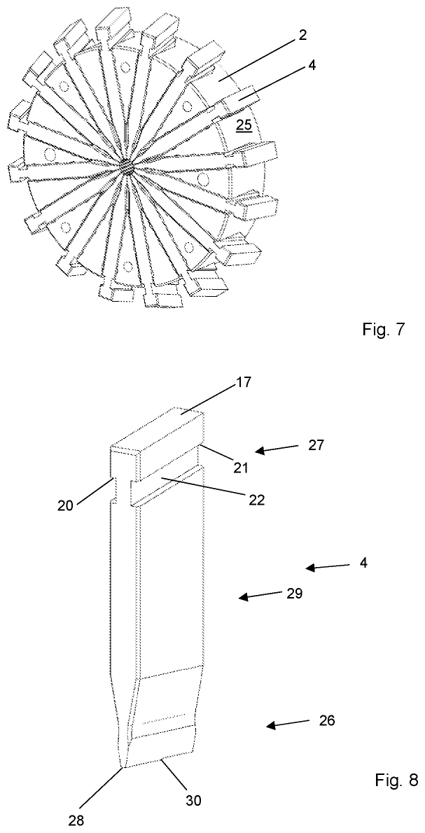

FIG. 7 shows a perspective view of the retaining ring 2 as well as of all the crimping jaws accommodated in a radially displaceable manner in the retaining ring 3, one of which is identified by the reference number ‘4’. The detachable cover plate shown in FIG. 2 covering the plate-shaped annular body of the retaining ring 2 is not shown, so that in the position shown in FIG. 7, each of the crimping jaws 4 is arranged interchangeably in the respective receiving groove. The receiving groove is open on the front side of the annular body of the retaining ring 2 shown in FIG. 7 and closed on the rear side shown in FIG. 7. Furthermore, the receiving groove is laterally delimited by groove flanks, so that the respective crimping jaw 4 is accommodated in the respective receiving groove such that it can be slidably guided in only one direction, namely the radial direction, in relation to the axis of the annular body of the retaining ring 2. It can further be seen that the respective crimping jaw 4 protrudes radially outwards over a cylindrical outer side 25 of the retaining ring 2, in particular, also in the crimping position shown in FIG. 7, in which the crimping jaws 4, insofar as the guidance of the crimping jaws 4 in the actuating ring 3 not shown permits, are displaced radially furthest towards the axis and towards the crimping barrel. The likewise essentially cylindrical inner surface of the actuating ring 3 is slidingly guided on the outer side 25 of the retaining ring 2. The plate-shaped annular body of the retaining ring 2 is thereby configured in one piece, for example a molded part made of a plastic or a metal.

FIG. 8 shows a perspective view of the crimping jaw 4. The crimping jaw 4 is configured as a one-piece, metallic molded part. The crimping jaw 4 has a first, radially internal end section 26 pointing towards the crimp barrel to be crimped and a second, exterior end section 27 pointing radially outwards from the crimp barrel to be crimped.

A crimping surface 28 is formed at one end of the first end section 26, which, in the crimping position, is in contact with the outer side of the crimp barrel and which defines the contour of the deformed crimp barrel section-wise during the plastic deformation of the crimp barrel under the effect of radial force. In particular, a step 30 is formed in the region of the crimping surface 28, which crimps the crimp barrel in a stepped manner when it is crimped, such that a first section of the crimped crimp barrel has a first diameter and a second section of the crimped crimp barrel has a second diameter, the two sections of the crimp barrel merging into one another in the region of a crimp barrel step.

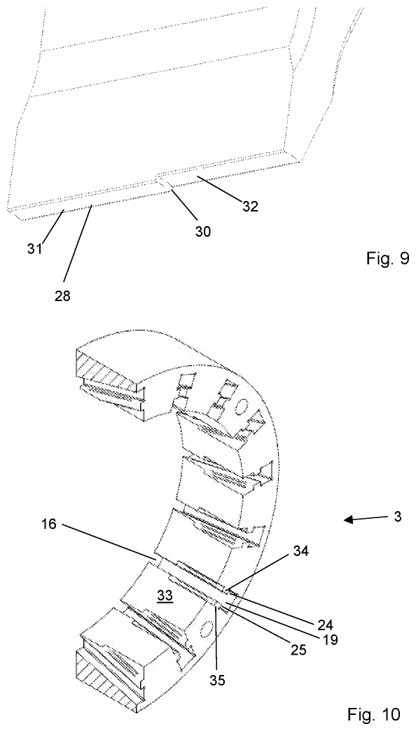

FIG. 9 shows a perspective sectional view from below of the first end section 26 of the crimping jaw 4, in particular showing the step 30 and the two axially spaced crimping surface sections 31 and 32, which merge abruptly into each other in the region of the step 30. It can also be seen that the two crimping surface sections 31 and 32 are slightly convex, so that the crimped crimp barrel has a rounded circumferential profile. The contouring of the crimping surface 28 makes it possible to crimp the crimp barrel with two different diameters in a single stroke of the respective crimping jaw 4, for example to crimp a first section of the crimp barrel onto the exposed conductor in the region of the first crimping surface section 31 and to crimp a second section of the same crimp barrel onto a section still provided with the cable sheath in the region of the second crimping surface section 32. The step 30 is formed in the direction of the axial extent of the crimping surface 28 and divides the crimping surface into the axially spaced crimping surface sections 31, 32 adjoining one another in the region of the step 30.

As FIG. 8 shows, an intermediate section 29 is provided between the first end section 26 and the second end section 27, the two lateral surfaces of which are guided in the receiving groove in the retaining ring 2. The crimping jaw 4 tapers in two stages from the intermediate section 29 radially in the direction of the first end section 26.

The second end section 27 of the crimping jaw 4 in the illustration of FIG. 8 has an essentially T-shaped configuration, so that the T-shaped second end section 27 of the crimping jaw 4 is guided in the guide groove 16 in the actuating ring 3.

On the crimping jaw 4, the pressure surface 17 is configured such that the pressure surface 17 interacts with the counter-pressure surface 18 of the actuating ring 3; in particular, the pressure surface 17 is formed on a head side of the crimping jaw 4 facing away from the axis of the retaining ring 2. The pressure surface 17 is configured as a flat surface section that is inclined towards the axis of the retaining ring 2.

The pressure surface 17 on the radially outer head side of the crimping jaw 4 interacts with the counter-pressure surface 18 on the actuating ring 3 in such a way that when the actuating ring 3 is axially displaced in the first direction 6, the counter-pressure surface 18 and the pressure surface 17 radially displace the crimping jaw 4 into the crimping position, as described in more detail above with reference to FIGS. 2 and 3.

FIG. 8 further shows the active surface formed on the crimping jaw 4, in particular on the T-shaped second end section 27, wherein the active surface on the crimping jaw 4 has the first surface section 20 and the second surface section 21. The two surface sections 20, 21 lie opposite each other in the region of the shaft 22 of the crimping jaw 4 and are formed on both sides of the shaft 22.

FIG. 8 further shows that the crimping jaw 4 has the essentially T-shaped second end section 27, whereby the pressure surface 17 is formed on the radially exterior side, namely the head side of the T, and the active surface, namely the two surface sections 20, 21, on the radially inwardly facing side of the T.

FIG. 8 also shows that the vertical bar of the ‘T’ is formed by the shaft 22, and the horizontal bar of the ‘T’ is formed by the widened section between the two surface sections 20, 21 and the pressure surface 17.

As can also be seen from FIG. 3 and FIG. 6, it is provided that the T-shaped second end section 27 of the crimping jaw 4 is guided in the guide groove 16 in the actuating ring 3. It can also be seen, in particular from FIG. 8, that the pressure surface 17 of the crimping jaw 4 shown there is parallel to the active surface, in particular parallel to each of the two surface sections 20, 21.

As can also be seen in particular from FIG. 6, the counter-pressure surface 18 of the actuating ring 3 for the crimping jaw 4 is formed parallel to the active section interacting with this crimping jaw 4, in particular parallel to each of the two surface sections 23, 24 of the actuating ring 3.

The T-shaped second end section 27 of the crimping jaw 4 is guided in the guide groove 16 in the actuating ring 3. As can be seen in particular from FIG. 7, the second end section 27 is also provided radially outside the cylindrical outer side 25 of the retaining ring 2 in the crimping position, in which the crimping jaws 4 are displaced radially furthest inwards, towards the crimping sleeve, and is accommodated within the guide groove 16 of the actuating ring 3 not shown in FIG. 7.

FIG. 10 shows the actuating ring 3 in a partially sectioned perspective view. The actuating ring 3 is configured as a ring part, the cylindrical inner side 33 of which is guided, in particular slidingly guided, on the likewise cylindrical outer side 25 of the retaining ring 2. In the crimping position, in which the crimping jaws 4 are displaced radially inwards towards the crimp barrel, it is provided that the actuating ring 3 is completely displaced onto the outer circumference of the retaining ring 2.

The guide grooves 16 are configured as inwardly open grooves, the respective groove base 19 of which is arranged at an angle in relation to the ring axis of the ring part. The respective guide groove 16 is laterally delimited by two protrusions 34, 35, on the radially outwardly facing sides of which the surface sections 24, 25 of the active section are formed, so that the active section, in particular its surface sections 24, 25, is formed on the radially outwardly facing surface of a respective protrusion 34, 35 protruding into the guide groove 16. The shank 22 of the respective crimping jaw 4 is accommodated between the two projections 34, 35, so that the T-shaped second end section 27 of the respective crimping jaw, in particular the vertical bar of the ‘T’, is accommodated in the actuating ring 3, namely in its guide grooves 16.

It is further provided that a radial distance between the surface section 24 (and/or 25) and the groove base 19 (and/or the counter-pressure surface 18) is configured to be greater than a radial distance between the pressure surface 17 of the crimping jaw 4 (FIG. 8) and the surface section 10 (and/or 21) of the same crimping jaw 4 (FIG. 8), so that the second end section 27, in particular the horizontal bar of the ‘T’, is accommodated in the guide groove 19 with a clearance in the radial direction, i.e. essentially with a clearance along the extension of the radially arranged crimping jaw 4. Because the T-shaped end section 27 of the crimping jaw 4 is arranged in the guide groove 16 with radial clearance, a gap is formed. This gap is formed between the surface sections 20, 21 and the surface sections 24, 25 (FIG. 3) when the actuating ring 3 is displaced in the first direction (arrow 6 in FIG. 2), and between the pressure surface 17 and the counter-pressure surface 18 (FIG. 6) when the actuating ring is displaced in the second direction (arrow 8 in FIG. 5). The gap moves thereby when the direction in which the actuating ring 3 is axially displaced changes. This ensures that either only the pressure surface 17 interacts with the counter-pressure surface 18 in a planar sliding manner, so that the crimping jaw 4 is displaced radially inwards (FIGS. 2 and 3), or that the surface sections 20, 21 of the active surface interact with the surface sections 24, 25 of the active section in a planar sliding manner, so that the crimping jaw 4 is displaced radially outwards, away from the crimping position (FIGS. 5 and 6).

The crimping unit 1 described above is part of a crimping tool, in particular a hand-operatable crimping tool, i.e. as a hand tool that comprises the crimping unit as a component. The in particular hand-operatable crimping tool further comprises a housing on which the retaining ring 2 of the crimping unit 1 is fixedly arranged. The crimping tool further comprises a drive arranged inside or outside adjacent to the housing, which is configured as a linear drive and comprises a shaft or a piston, wherein the hydraulically or pneumatically driven piston acts directly or indirectly on the actuating ring 3. For an indirect acting of the shaft or the piston of the linear drive on the actuating ring 3, a rigid coupling element can be provided in particular, to which the shaft is articulated on the drive side and which is attached to the actuating ring 3 at several points in the circumferential direction of the actuating ring 3. The drive can be provided via a motor-driven threaded spindle or hydraulically via a pressing tool or mechanically, derived from the swivel movement of two tong halves.

In a further development of the crimping unit described above, parts guided slidingly on one another could be provided with a friction-reducing or wear-reducing coating or the surfaces could be treated accordingly to reduce friction or wear. This applies, for example, to the inner side 33 of the actuating ring 3 in relation to the outer side 25 of the retaining ring 2 or the radial guidance of the crimping jaws 4 in the receiving grooves in the retaining ring 2.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 crimping unit
2 retaining ring
3 actuating ring
4 crimping jaw
5 near-axis region
6 first axial direction
7 first radial direction
8 second axial direction
9 second radial direction
10 insertion opening
11 cover plate
12 end part
13 cone-like protrusion
14 recess of the cover plate 11
15 crimping surface
16 guide groove
17 pressure surface
18 counter-pressure surface
19 groove base of the guide groove 16
20 first surface section of the active surface
21 second surface section of the active surface
22 shank of the crimping jaw 4
23 first surface section of the active section
24 second surface section of the active section
25 outer side of the retaining ring 2
26 first end section of the crimping jaw 4
27 second end section of the crimping jaw 4
28 crimping surface
29 intermediate section
30 step on the crimping surface 28
31 first crimping surface section
32 second crimping surface section
33 inner side of the actuating ring 3
34 protrusion
35 protrusion

What is claimed is:

1. A crimping unit for radially crimping a crimp barrel along a circumference of the crimp barrel onto a cable, the crimping unit comprising:
a plurality of radially displaceable crimping jaws arranged in a circumferential direction, which press the crimp barrel onto the cable in a crimping position;
a retaining ring, in which the crimping jaws are accommodated in a radially displaceable manner; and
an actuating ring, which is axially displaceable in relation to the retaining ring,
wherein, upon an axial displacement of the actuating ring in a first direction, the crimping jaws in the retaining ring are radially displaceable into the crimping position, and
wherein the actuating ring is configured such that, in case of an axial displacement of the actuating ring in a second direction opposite to the first direction, an active section of the actuating ring interacts with an active surface of a respective one of the crimping jaws such that the respective crimping jaw is movable from the crimping position into a radially spaced position.

2. The crimping unit according to claim 1, wherein the active surface on the respective crimping jaw has a first surface section and a second surface section, and wherein the two surface sections lie opposite each other in a region of a shank of the respective crimping jaw.

3. The crimping unit according to claim 1, wherein the active section of the actuating ring has a first surface section and a second surface section, and wherein the two surface sections are arranged in a spaced apart manner by the respective crimping jaw.

4. The crimping unit according to claim 1, wherein the respective crimping jaw has a step on a crimping surface in a direction of axial extent.

5. The crimping unit according to claim 1, wherein the retaining ring is configured as an annular body with receiving grooves each configured to receive one of the crimping jaws and has a cover plate axially covering the retaining ring.

6. The crimping unit according to claim 1, wherein a pressure surface is formed on the respective crimping jaw, and wherein a counter-pressure surface for the pressure surface of the respective crimping jaw is formed on the actuating ring, and wherein the actuating ring is configured in such a way that, during the axial displacement of the actuating ring in the first direction, the counter-pressure surface of the actuating ring interacts with the pressure surface of the respective crimping jaw in such a way that the respective crimping jaw is radially displaceable into the crimping position.

7. The crimping unit according to claim 6, wherein the pressure surface of the respective crimping jaw is formed parallel to the active surface of the respective crimping jaw, and wherein the counter-pressure surface of the actuating ring of the respective crimping jaw is formed parallel to the active section of the actuating ring cooperating with the respective crimping jaw.

8. The crimping unit according to claim 6, wherein the respective crimping jaw has a substantially T-shaped end section, and wherein the pressure surface is formed on a radially outer side of the T-shaped end section and the active surface is formed on the radially inwardly pointing side of the T-shaped end section.

9. The crimping unit according to claim 8, wherein the T-shaped end section of the crimping jaw is configured to be guided in a guide groove in the actuating ring, and wherein the counter-pressure surface is formed on a radially inwardly pointing groove base and the active section is formed on a radially outwardly pointing surface of a protrusion protruding into the guide groove.

10. The crimping unit according to claim 9, wherein the T-shaped end section of the crimping jaw is arranged in the guide groove with a radial clearance.

11. The crimping unit according to claim 1, wherein, in the crimping position, the actuating ring is completely displaced onto an outer circumference of the retaining ring.

12. A crimping tool, comprising:
a housing; and
the crimping unit according to claim 1 arranged in the housing,
wherein the retaining ring is fixedly arranged on the housing.

13. The crimping tool according to claim 12, further comprising a drive arranged on or in the housing.

14. The crimping tool according to claim 13, wherein the drive is configured as a linear drive with a linearly driven shaft or a piston, and wherein the shaft or the piston acts on the actuating ring.

15. The crimping tool according to claim 14, wherein a rigid coupling element is provided between the shaft and the actuating ring, wherein the shaft or the piston is articulated to the coupling element on the drive side and wherein the coupling element is fastened in the circumferential direction of the actuating ring at a plurality of points.
